(19) United States
(12) Patent Application Publication
(10) Pub. No.: US 2012/0074193 A1
(43) Pub. Date: Mar. 29, 2012

(54) DISPENSER FOR ROLL MATERIALS

(76) Inventor: SOTIRIA EFTHIMIADIS, VALATIE, NY (US)

(21) Appl. No.: 13/184,637

(22) Filed: Jul. 18, 2011

Related U.S. Application Data
(63) Continuation of application No. 12/892,695, filed on Sep. 28, 2010.

(51) Int. Cl. B26F 3/02

(52) U.S. Cl. 225/39

(57) ABSTRACT

A dispenser for roll materials includes a cabinet for storing and dispensing an individual sheet from a roll of sheet material stored one or more compartments. A front cover is disposed over the front of the cabinet. A cutting blade is disposed on the front cover which has a dispensing opening therethrough with a cutter blade adjacent to the dispensing opening. The cutter blade may be secured to the interior surface of the front cover covered by a blade guard that is pivotally secured over the cutter blade to protect user accessing material in a dispensing path. Alternatively the cutter blade can be disposed for operating in a slotted track to which the cutting blade is attached providing access to the free end of the roll material after each cut.

This application is a continuation-in-part of copending U.S. patent application of Sotiria Efthimiadis Ser. No. 12/892,695 filed 28 Sep. 2010 which was entitled “Dispenser For Roll Materials.”

### BACKGROUND OF THE INVENTION

1. Field of the Invention

The present invention relates generally to dispensing devices, and more particularly to dispensing devices for cutting individual sheets from rolls of material, such as aluminum foil, plastic wrap, and wax paper as commonly used in the kitchen, although the dispenser may be used in other areas and/or configured or scaled up for the dispensing of other roll materials.

2. Description of the Related Art

Provision of thin, flexible sheet material on rolls is well known. Conventionally, aluminum foil, plastic wrap, wax paper, and similar materials are supplied in roll form, with a single roll contained within a box or carton. Usually, the box or carton is equipped with a cutting edge for cutting sheets of the material from the roll as desired. A problem with individually boxed rolls of material is that storage space must be provided for the cartons. Storage space is at a premium in kitchen areas, so valuable space must be found on a cabinet or countertop or in a drawer.

Disposable cartons supplied with such roll material are relatively cheap and the cutting edge provided therewith are also relatively cheap. Thus such cartons with their cutting edges often fail to do a good job of dispensing and cutting the roll material into individual sheets. The material will often snag or hang up in the carton or on an edge as it is being dispensed, and use of such an inexpensive and poor quality cutting edge to cut a length of roll material often results in an uneven cut or tearing of the material. In addition when cutter blades in such disposable cartons are exposed there is a risk of injuries to users.

The time required for a user to access and cut an individual sheet from a dispenser successfully is important especially in commercial operations such as kitchens in business establishments, and in that regard there has been a problem with currently available sheet material dispensers.

While holders and the like for disposable paper towels are well known, they are generally mounted beneath an existing cabinet, separate from other roll materials. Such holders work well for goods such as paper towels, which are conventionally provided with perforations to facilitate the separation of short lengths from the roll without requiring a cutting device. However, such holders are not suitable for roll materials provided in continuous, unbroken lengths, as they cannot provide a cutting edge for the separation of a length of material from the roll.

Thus, a dispenser for roll materials solving the aforementioned problems is desired.

### SUMMARY OF THE INVENTION

In accordance with this invention a dispenser for roll materials is provided. A back housing has a front, a back panel and mutually opposed left and right sides with at least one shelf extending between the left and right sides. The shelf extends forward from the back panel towards the front of the back housing and the shelf has a shelf front at the front of the back housing. The shelf front has a downwardly sloped forward edge which comprises a front ledge or a front access recess extending downwardly from the shelf. is removably installed over the back housing to form the assembled dispenser. When the dispenser is assembled with the front cover is installed, the front cover has at least one sheet passageway formed therethrough aligned with the forward edge the assembled dispenser when the; the front cover and the back housing forming a compartment above the shelf; the downwardly sloped forward edge and the sheet passageway providing a dispensing path communicating through the sheet passageway of the front cover and across the downwardly sloped forward edge with the compartment; and cutter means including a cutter blade proximate to the front cover for cutting sheet material in the dispensing path.

Further in accordance with this invention, a dispenser for roll materials is provided for the convenient storage and dispensing of one or more rolls of material therein, while also providing one or more cutting tools therewith for separating short lengths of material from the rolls. A dispenser cabinet includes an openable or removable front cover. The cabinet includes one or more individual roll storage compartments. The front cover has a corresponding number of dispensing openings and cutting blades therein.

Preferably the dispenser includes a cabinet adapted for permanent attachment to a vertical surface, such as a wall, door, or kitchen cabinet door or side.

The cutting implements are located on or proximate to the front cover of the cabinet. A dispensing opening is provided across the span beneath the cutter bridge or handle. As the cutter separates the sheet material below the edge of the dispensing opening, a free end of the material is always provided in the dispensing opening for the user to grasp and pull from the dispenser when needed. The actual cutting element extends from the cutter somewhat below the track and slide. A lateral slotted track is formed in the front cover. Each cutter has a retaining slide mechanism captured in the slotted track. A bridge serving as a handle extends between the slide and the cutting implement.

The dispenser for roll materials may include one or more roll storage compartments or shelves. There is preferably a separate compartment for each type of roll material to be used. The dispenser for roll materials is particularly useful for storing and dispensing roll materials commonly used in the kitchen, e.g., aluminum foil, plastic wrap, and wax paper, but may be used for the storage and dispensing of other roll materials at other locations. An optional paper towel holder may be mounted beneath the cabinet, if so desired.

These and other features of the present invention will become readily apparent upon further review of the following specification and drawings.

### BRIEF DESCRIPTION OF THE DRAWINGS

FIG. 1 is an environmental, perspective view of a first embodiment of a dispenser for roll materials according to the present invention, illustrating various features thereof.

FIG. 2 is a partial perspective view of a partially modified embodiment of the dispenser of FIG. 1, broken away and partially in section to show further details thereof.

FIG. 3 is a side elevational view in section of a second embodiment of a dispenser for roll materials according to the present invention.

FIG. 4 is a detailed perspective view of one of the cutter assemblies for of a dispenser for roll materials according to the present invention, with an alternative embodiment cutting element shown exploded away from the cutter assembly.

FIG. 5A is a perspective, pictorial, elevational view of an assembled two roll dispenser for dispensing individual sheets of roll material in accordance with this invention. The dispenser comprises a cabinet formed by a front cover and a housing for storing rolls of sheet material and for a user to cut individual sheets of the sheet material from the rolls stored in the housing. FIG. 5B is a front perspective view at a reverse angle relative to FIG. 5A of the housing of FIG. 5A. FIG. 5C is a front perspective view at the same reverse angle relative to FIG. 5A of a front cover of the housing of FIG. 5A.

FIG. 6A is a line drawing of a front elevational view of the front housing of the two roll dispenser 210 of FIG. 5C. FIG. 6B is line drawing of a plan view of the dispenser 210 shown FIG. 6A. FIG. 6C is line drawing of a right elevational view of the dispenser 210 shown FIG. 6A.

FIGS. 7A-7C are three views of an exemplary pivotable blade guard. FIG. 7A is a front elevation, FIG. 7B is a plan view and FIG. 7C is a right elevation.

FIGS. 8A-8C are views of a serrated cutter blade shown installed in FIGS. 10B and 14A-14C which is exemplary of the cutter blades of this invention. FIG. 8A is a front elevation, FIG. 8B is a plan view and FIG. 8C is a right elevation.

FIG. 9 is a pictorial, elevation of the assembled dispenser of FIGS. 5A-5C.

FIGS. 10A and 10B are right side elevations of the dispenser of FIGS. 5A and 9.

FIG. 10B is a section taken along line A-A′ in FIG. 9 showing the interior of the dispenser.

FIG. 11 is a plan view of the front cover of the dispenser of FIG. 10A.

FIGS. 12A-12C are three views of the back housing of the dispenser for storing rolls of sheet material to be cut and dispensed as individual sheets. FIG. 12A is a front elevation, FIG. 12B is a plan view and FIG. 12C is a left elevation on the right side of the front elevation.

FIG. 13 is an exploded view of the two roll dispenser of FIGS. 5A and 9.

FIGS. 14A-14C are partial sections of one of the compartments of the dispenser illustrating the sequence of cutting of a roll of sheet material into an individual sheet and showing operation of a cutter blade and the blade guard juxtaposed with the cutter blade to protect users of the dispenser.

FIG. 15 shows the dispenser of FIGS. 5A and 5C including the front including the front cover with the blade guards removed showing the location of the serrated cutter blades above the open windows and the access recesses.

Similar reference characters denote corresponding features consistently throughout the attached drawings.

### DETAILED DESCRIPTION OF THE PREFERRED EMBODIMENTS

The dispenser for roll materials of this invention may provide for the storage and dispensing of one or more rolls of material, and is particularly well suited for use in the kitchen for dispensing such materials as wax paper, aluminum foil, and plastic wrap. However, it will be recognized that the device may be scaled up for dispensing material normally supplied on larger rolls, such as fabric goods and the like.

### First Embodiment

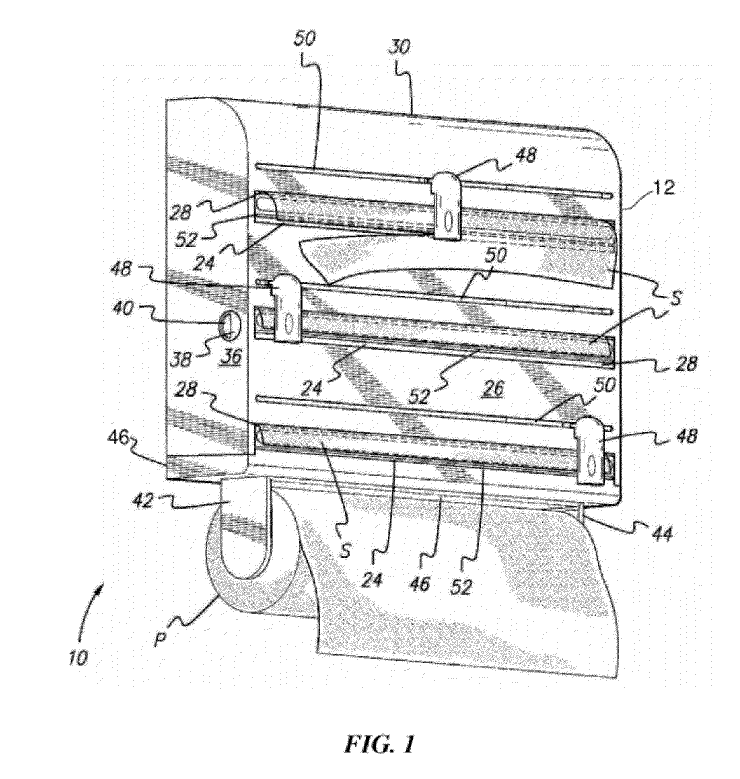

FIG. 1 of the drawings provides a perspective view of a first embodiment of with this invention of a three-roll dispenser 10 including a cabinet 12 with three stacked compartments for dispensing and cutting of or each type of roll material to be used. The cabinet 12 provides for both storage and dispensing for three rolls of sheets S of different materials contained therein, but it will be seen that the dispenser 10 may be configured to hold and dispense more or fewer rolls of material. An optional feature of this invention comprises provision of paper towel holder arms 42 and 44 secured to the bottom thereof for holding a fourth roll of paper towels on paper towel roll P.

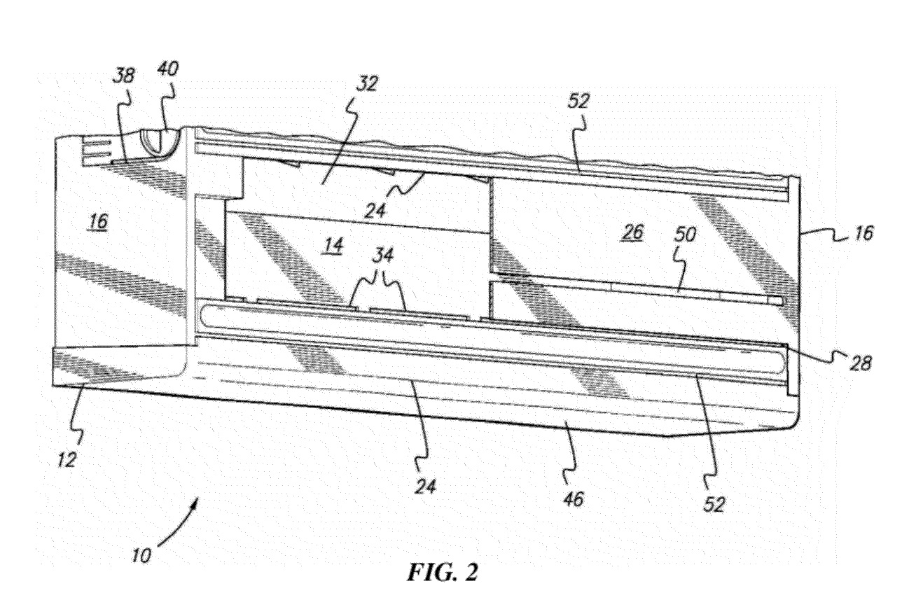

The three-roll dispenser 10 for dispensing the sheets S of materials includes a cabinet 12 with some elements concealed behind the front cover 26 in FIG. 1. FIG. 2 shows more details of the three-roll dispenser 10. The cabinet 12 includes a top panel 30, a bottom panel 46 and a back panel 14 with a pair of mutually opposed left and right side panels 16 and 18 shown on either side of the back panel 14 in FIG. 2. The back panel 14 is adapted for mounting to any convenient and substantially vertical surface, e.g., the side of an existing cabinet, a wall, or a door using screws, adhesives, or other conventional attachment means. The back panel 14 need not be continuous, but may comprise a plurality of sections in order to save material.

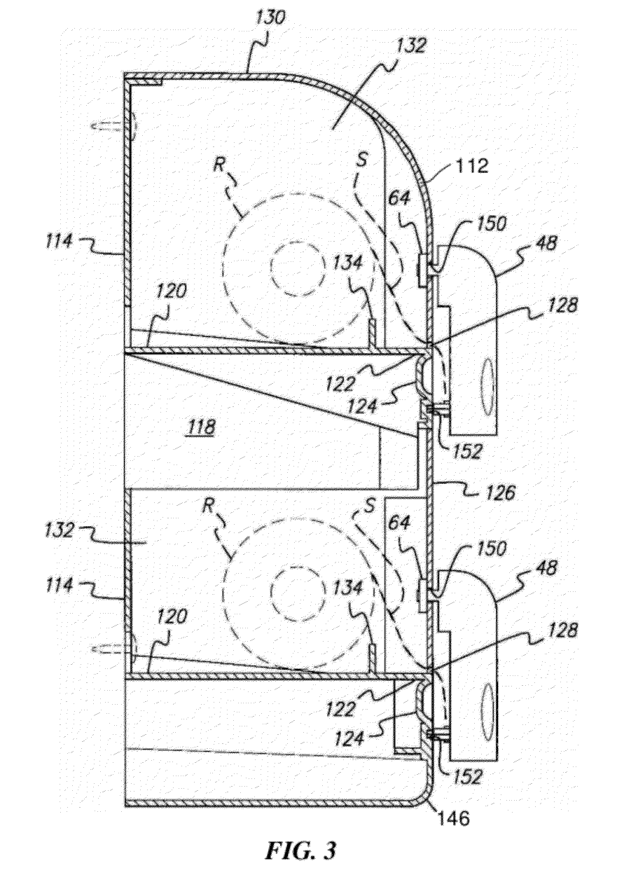

The cabinet and cover are preferably formed of a resilient material which provides for other features as well. FIG. 1 shows a pair of optional paper towel holder arms 42, 44 depending from the bottom panel 46 of the cabinet 12. The bottom panel 46 extends between the left and right side panels and forward from the back panel of the cabinet. The lower portion of the dispenser 10 of FIG. 2 may be equipped in the same manner, if so desired. As the paper towel holder assembly is optional, it is not shown in FIG. 2 in order to illustrate this configuration. However, it will be seen that such arms may be provided with the dispenser 110 of FIG. 3, so that the towel holder would depend from the bottom panel 146 of the cabinet 112.

The two optional paper towel holder arms 42, 44 are preferably formed as integral components of the resilient plastic cabinet 12/112. The flexible nature of the material allows the two arms to be spread apart from one another to grip the core of a paper towel roll P therebetween, as is known in the art. Alternatively, the two arms 42, 44 may be spring-biased toward one another to grip the paper towel roll P therebetween. The term “flexible” is intended to include both the flexible mounting or attachment of integral paper towel holder arms, as well as hinged arms that are mechanically biased toward one another by springs or the like.

### Second Embodiment

FIG. 3 illustrates a two-roll dispenser 110 in a cabinet 112 Both the three-roll dispenser 10 and the two-roll dispenser 110 differ only in the number of compartments provided for roll storage and have various components in common with one another. While the left side panel is not shown in FIG. 3 for convenience of illustration, several shelves extend forward from the back panel 114 between the two left and right side panels, as shown by the shelves 120 of the dispenser 110 extending from the back panel 114 and to the left of the right side panel 118. As in the first embodiment, the back panel 114 need may comprise a plurality of sections in order to save material. The right side panel 18 of the three-roll dispenser 10 of FIG. 1 is similar to, but somewhat taller than, the right side panel 118 of the two-roll dispenser 110 of FIG. 3. Each shelf 120 has a forward edge 122 and a front ledge 124 depending therefrom. This configuration is also carried out in the three-roll dispenser 10 illustrated in FIGS. 1 and 2, with only the front ledges 124 of FIG. 3 being shown in the drawings.

### Cabinet Structures for First and Second Embodiments

Both of the first and second embodiments of the dispensers 10/110 include a front cover 26/126 that is removably installed over the cabinet 10/110, as shown with the front cover 26 in FIGS. 1 and 2 and the front cover 126 in FIG. 3. The front cover 26/126 includes a relatively wide sheet passageway 28/128 formed therethrough for each roll of material to be contained within the dispenser, the corresponding front ledge 24/124 protruding through the front cover 26/126 and defining a relatively narrow gap forming a dispensing path between the front ledge 24/124 and the edge of the sheet passageway 28/128 to control the path of the sheet material dispensed therefrom. The various panels of the cabinet 112, e.g., left side panel (not shown in FIG. 3) and its opposite right side panel 118 of the dispenser 110 of FIG. 3, its back panel 114, each of its shelves 120 and their front ledges 124, and the top panel 130 of the front cover 126, define a plurality of compartments 132 therein, each corresponding sheet passageway 128 communicating with its respective compartment 132 within the dispenser 110. While the top of the uppermost compartment 132 is defined by the top panel 130 of the front cover 126, the tops of the other compartments 132 are defined by the respective overlying shelf 120. The corresponding uppermost compartment 32 of the dispenser 10 shown in FIG. 2 is covered by the top panel 30 of its front cover 26 in FIG. 1.

Each compartment 132 is adapted for the storage therein and dispensing therefrom of roll material R, e.g., plastic wrap, aluminum foil, wax paper, etc. Additional security for the rolls R contained within the compartments 132 is provided by a series of roll retainers 34/134 extending upwardly from the forward portion of each shelf 120, generally opposite the forward ledge 124 of the shelf. In FIG. 2, the lowermost compartment 32 and the uppermost edges of the corresponding roll retainers 34 of the dispenser 10 are shown in the left portion of FIG. 2, i.e., the portion of the dispenser 10 having the cover 26 removed to expose details of the underlying cabinet 12.

The various embodiments of the cabinets and their corresponding covers shown in FIGS. 1-3 are preferably formed of an at least somewhat flexible and resilient material, such as a durable plastic or the like. The front cover, e.g., the cover 26 of the dispenser embodiment 10 of FIGS. 1 and 2, includes mutually opposed left and right flanges extending from the lateral edges of the cover 26, the left flange 36 being visible in FIG. 1. Each of the lateral flanges includes a latch passage therethrough, e.g., the latch passage 38 of the left flange 36 of the cover 26. Each of the side panels of the cabinet, e.g., the left side panel 16 of the cabinet 12 shown in FIGS. 1 and 2, has a flexible or resilient latch 40 protruding slightly outwardly therefrom. The forward portion of the latch 40 is not attached to the cabinet side panel 16, but the rearward end of the latch 40 extends from the side panel 16 and is formed of the same material. When the front cover 26 is installed over the cabinet 12, the latches (e.g., latches 40) snap into place within the corresponding latch passages (e.g., latch passages 38) to secure the cover 26 to the cabinet 12. The cover 26 is easily removed from the cabinet 12 by pressing the latches 40 inwardly and sliding the cover 26 away from the cabinet 12.

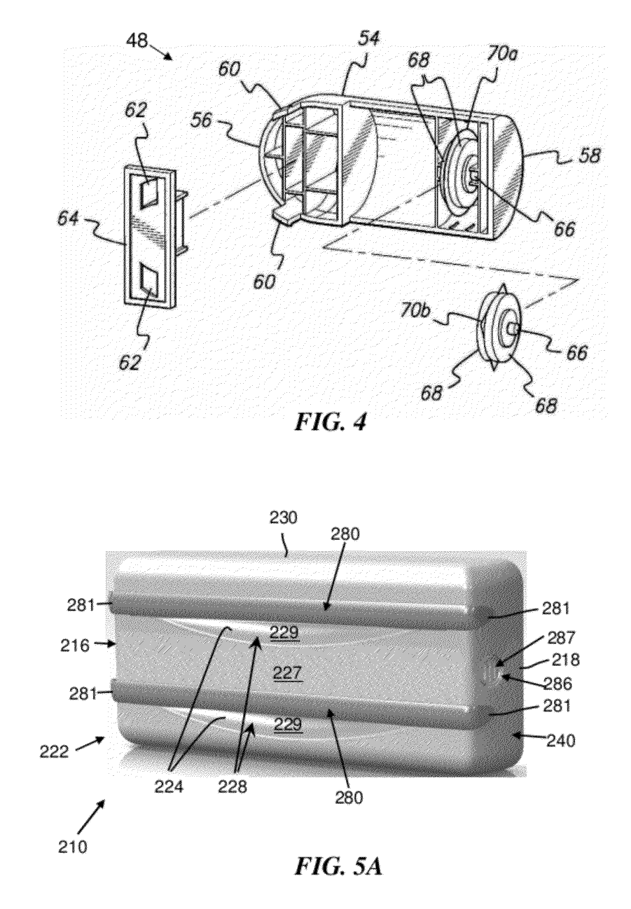

As paper towel rolls are conventionally provided with perforations to facilitate their separation as needed, no other means for separating such paper towel segments or lengths from one another need be provided. However, most other roll materials are provided as continuous and unbroken lengths of material, the user determining the appropriate length to be removed from the end of the roll for use. Thus, the dispenser includes a plurality of cutters 48 for cutting a sheet of material S from the corresponding roll R. Each cutter 48 is secured within and slides along a corresponding laterally disposed cutter track 50 formed above the corresponding sheet opening or passage 28 of the cover 26. Each cutter 48 includes a blade 70a/70b, shown in FIG. 4, and discussed in detail further below, that extends through the sheet passageway 28 of the cover to engage a corresponding laterally disposed blade slot 52 formed in the lower portion of each front ledge 24 of the cabinet 12. The corresponding components of the dispenser 110 of FIG. 3 are designated as cutter track 150 and blade slot 152.

### Cutter Mechanism and Cutter Blades for First and Second Embodiments

FIG. 4 provides a detailed illustration of an exemplary cutter 48, as installed with each of the dispenser embodiments. The cutter 48 is used in the above described embodiments of the dispenser, and includes an elongated handle 54 having a track end 56 and an opposite blade end 58. A slide apparatus comprising a pair of resilient barbed fingers 60 protrudes from the track end 56 of the handle 54, and engages corresponding passages 62 in a retaining member 64. The cutter 48 is secured to the front cover 26/126 by inserting the fingers 60 through one of the tracks 50/150, and snapping the retaining member 64 over the barbed ends of the fingers 60 from the back side of the cover 26 /126. The cutter 48 is thus secured to the cover 26, but is free to slide laterally along the track 50 by means of the fingers 60 extending through the track 50.

The opposite blade end 58 of the cutter 48 includes a short axle 66 having a pair of resilient rotary wheels 68 installed thereon. The axle 66 and the associated pair of wheels 68 are captured within the blade end 58 of the cutter 48. A circular blade 70a is captured between the pair of resilient wheels 68 and rotates therewith. The periphery of the blade 70a extends outward from the blade end 58 of the cutter handle 54. The resilient rotary wheels 68 bear against the underlying material, e.g., the protruding end of a sheet of aluminum foil or other material as dispensed from the corresponding compartment, the pair of resilient rotary wheels 68 rolling along the sheet material and the circular blade 70a engaging the blade slot 52/152) to cut the material along the line defined by the blade slot 52 and the travel of the circular blade 70a.

FIG. 4 also illustrates an alternative blade configuration, comprising a polygonal blade 70b (e.g., square, etc.) installed on an axle 66 between a pair of resilient rotary wheels 68. In this particular embodiment the polygonal blade 70b does not rotate within the blade handle 54, as the interior corner(s) of the polygonal blade 70b engage the interior of the blade end 58 of the blade handle 54 to hold the blade 70b stationary relative to the remainder of the cutter 48. Thus, the extended tip or corner of the polygonal blade 70b acts as a knife or razor blade, rather than rotating.

Referring to FIGS. 1 and 3, the device is loaded by removing the front cover 26/126 from the cabinet 12/112, removing the rolled material from its retail container, placing the roll R of material within the desired compartment, and extending the free end of the sheet S through the corresponding sheet passageway 28/128 of the front cover as it is reinstalled over the cabinet. The sheet of material extends through the relatively narrow gap between the upper edge of the sheet passageway and the upper edge of the corresponding front ledge 24/124 when the front cover is installed.

Material is cut to the desired length by pulling the exposed edge of the material from its sheet passageway gap as desired and sliding the cutter assembly 48 from one end of its track to the other, generally as shown by the uppermost cutter assembly in FIG. 1. It will be noted that the elongate cutter handle 54 spans the width of the exposed front ledge therebeneath, i.e., the path of the blade 70a/70b in its blade slot 52/152 is somewhat below the outlet gap for the sheet material. Thus, when a sheet S of material is cut, an exposed edge of the material equal in width to the height of the exposed front ledge remains available for the user to grasp for the next dispensing operation for that sheet S. A shallow groove or depression is provided in the face of the front ledge to facilitate grasping the free end of the sheet S of material to pull it from the dispenser 10/110 for the next use.

### Third Embodiment

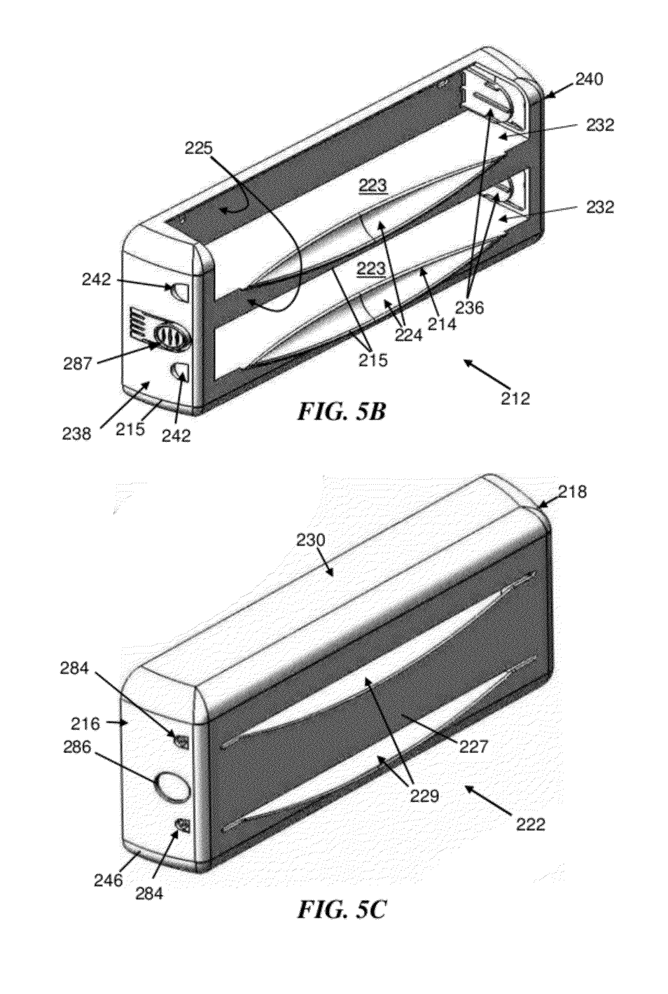

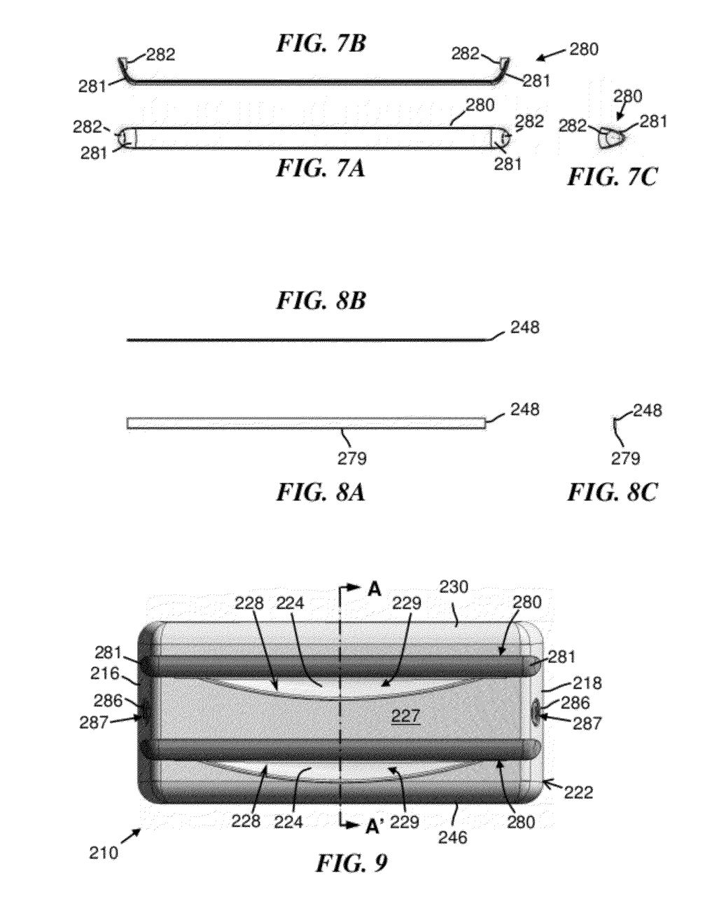

FIG. 5A is a front perspective view of a two roll dispenser 210 for dispensing individual sheets of roll material in accordance with this invention. The dispenser 210 comprises a cabinet formed by a front cover 222 and a back housing 212 for storing rolls of sheet material. The dispenser 210 is employed by the user to cut of the sheet material into individual sheets. FIG. 5B is a front perspective view at a reverse angle of the back housing 212 of FIG. 5A. FIG. 5C is a front perspective view at the same reverse angle of a front cover 222 of the dispenser 210 of FIG. 5A. Preferably the preferred composition of the plastic materials of which the dispenser 210 parts is selected from ABS (Acrylonitrile Butadiene Styrene) or HIPS (High Impact PolyStyrene) which have sufficient flexibility for assembly of the front cover 222 onto the back housing 212 and removal thereof from the back housing 212 as will be explained in more detail below. The same materials are suitable for use for the blade guards 280 described below with reference to FIGS. 7A-7C.

### Front Cover, Back Housing and Blade Guards

In FIG. 5A, the front cover 222 of FIG. 5C is shown assembled with the back housing 212 with a few features of the back housing 212 visible in that view as it is seen when the back housing 212 is assembled with the front cover 222 as it is when loaded with rolls of sheet material to be dispensed. While substantial portions of the front cover 222 are shown in FIG. 5A, the back housing 212 which is only partially visible in FIG. 5A is shown more fully in FIG. 5B. The blade guards 280 which cover cutter blades 248 therebehind are preferably retained in the lower position shown by gravity.

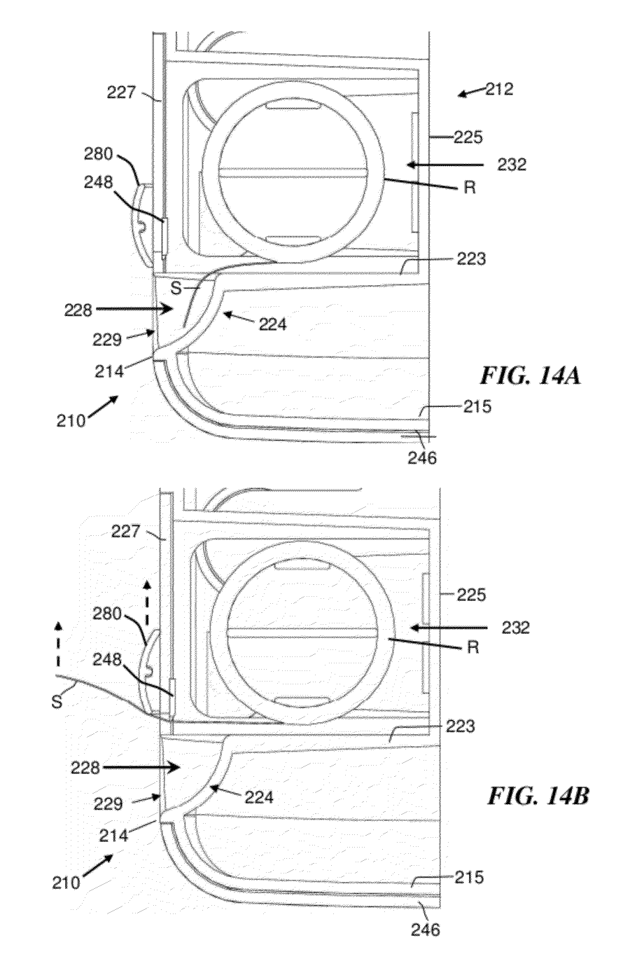

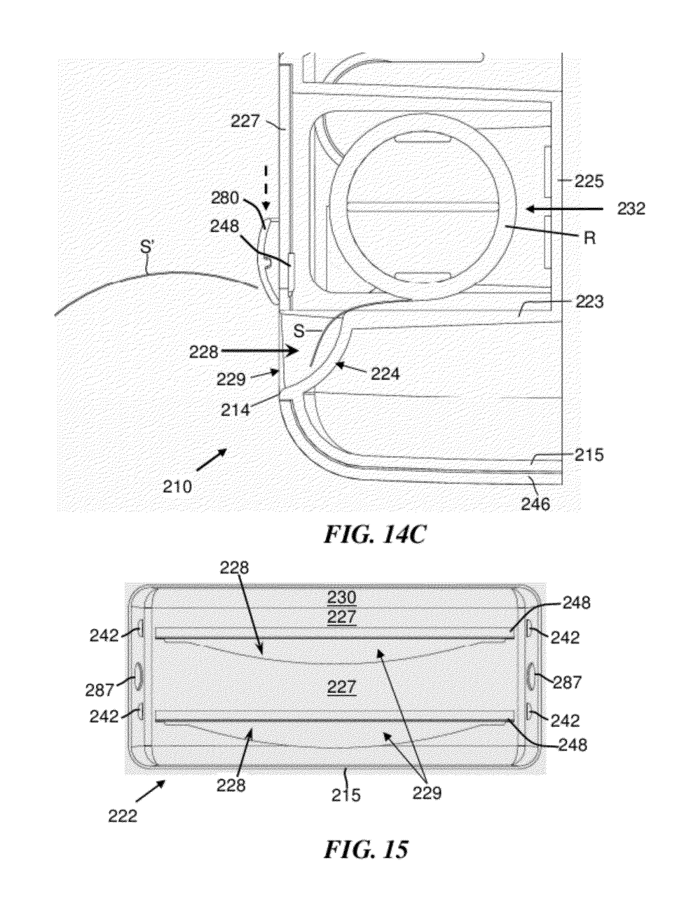

In FIG. 5A, the front cover 222 is shown to have a front panel 227 which includes upper and lower open, front access windows 229 therethrough. The two open, front access windows 229 extend horizontally exposing sloped forward edges of a shelf 223 in the form of a pair of downwardly curved, hand access recesses 224 on the forward edges of the shelves 223 in the back housing 212. A pair of wide sheet dispensing paths 228 are provided for dispensing sheet material from the dispenser 210 and cutting it into separate sheets S as it passes through the dispensing paths 228. The sheet dispensing paths 228 are formed by the spaced between the front access windows 229 through the front panel 222 of the front cover 222 and the hand access recesses 224 in the back housing 212 (shown in FIG. 5B) permit manual access to sheet material stored on the roll shelves 223 in the back housing 212 (shown in FIG. 5B) so that they can be dispensed as individual sheets from the dispenser 210. Those hand access recesses 224 are located below cutting cutter blades 248 (shown in FIGS. 8, 9A-9C, 10B, 13 and 14A-14C,) which are hidden behind the vertically pivoting blade guards 280 Each of the blade guards 280 is provided to protect the fingers and hands of a user from cutter blades 248 located behind the blade guards 280. In other words, the blade guards 280 permit safe access by the fingers of a user who accesses the wide sheet dispensing path 228 by reaching through a front access window 229 into one of the hand access recesses 224 to pull out a loose end of a sheet S of a roll R of material as illustrated by FIGS. 14A-14C stored in the back housing 212 and then to cut an individual sheet S of the material with a desired length from the roll R as is described in more detail below.

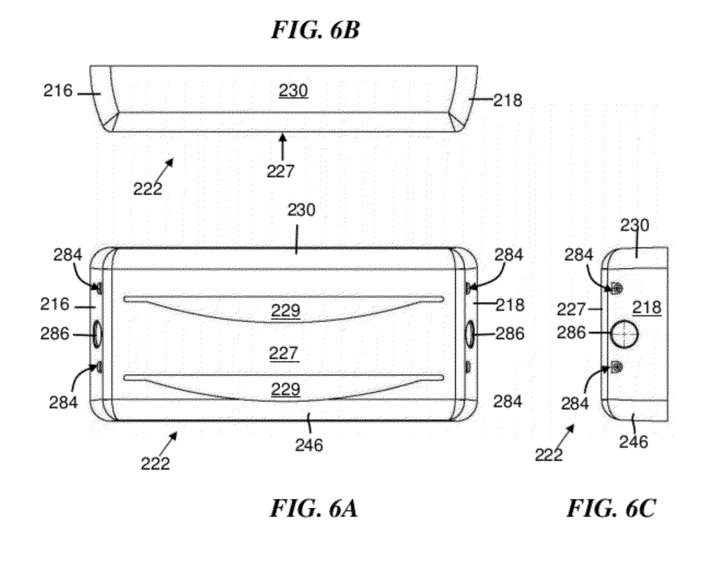

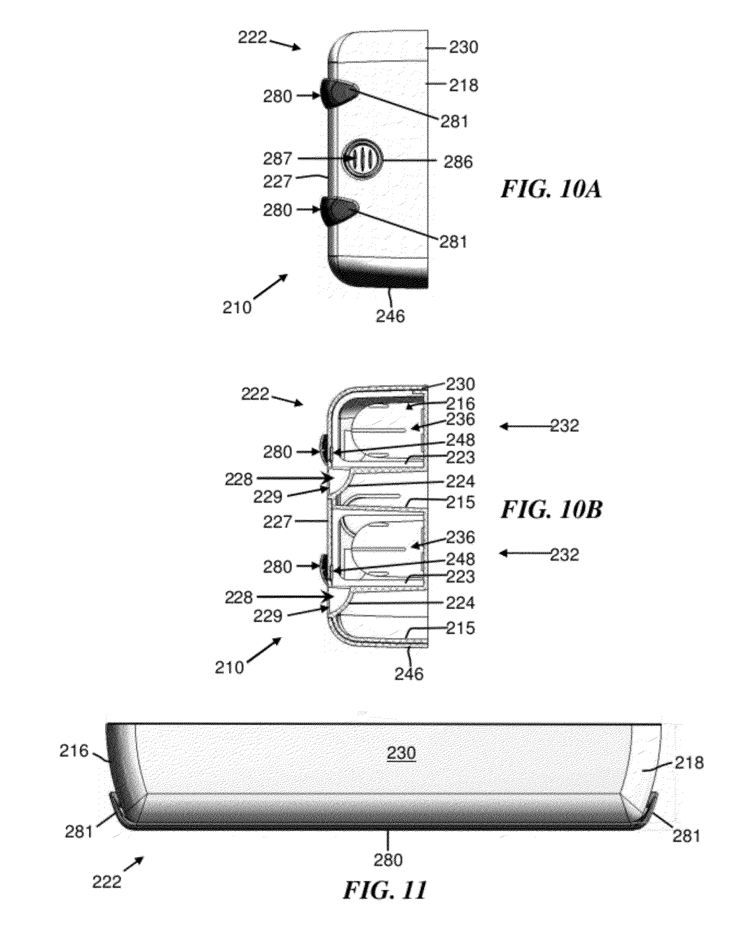

Thus, when in the normal lower position seen in FIGS. 10B and 14A, each vertically pivoting blade guard 280, which extends horizontally above a corresponding one of the dispenser path 228 provided by the two horizontally extending, front access windows 229 and the horizontally extending, hand access recesses 224, protects the fingers of the user when they are extended though a front access window 229 into a hand access recess 224. Referring to FIGS. 5A, 6A and 6C, the flexible front cover 222, a latch through hole 286 comprising a through-hole shown on the right sidewall 218 of the front cover 222 which is provided to latch the front cover to the back housing 212 when the button-shaped, i.e. annular latch bump 287 slides into place in the latch through hole 286 as the flexible front cover 222 closes onto the latch bump 287.

In operation, when the front cover 222 is installed over the back housing 212, the latch bumps 287 slide within the left sidewall 216 and the right sidewall 218 until they snap into place within the bilateral pair of latch through holes 286 to secure the font cover 222 to the back housing 212. The front cover 222 is easily removed from the back housing 212 by pressing the latch bumps 287 inwardly behind the edges of the latch through holes 286 inside the sidewalls 216 and 218 to release the latch and then sliding the font cover 222 away from the back housing 212.

### Housing of Dispenser

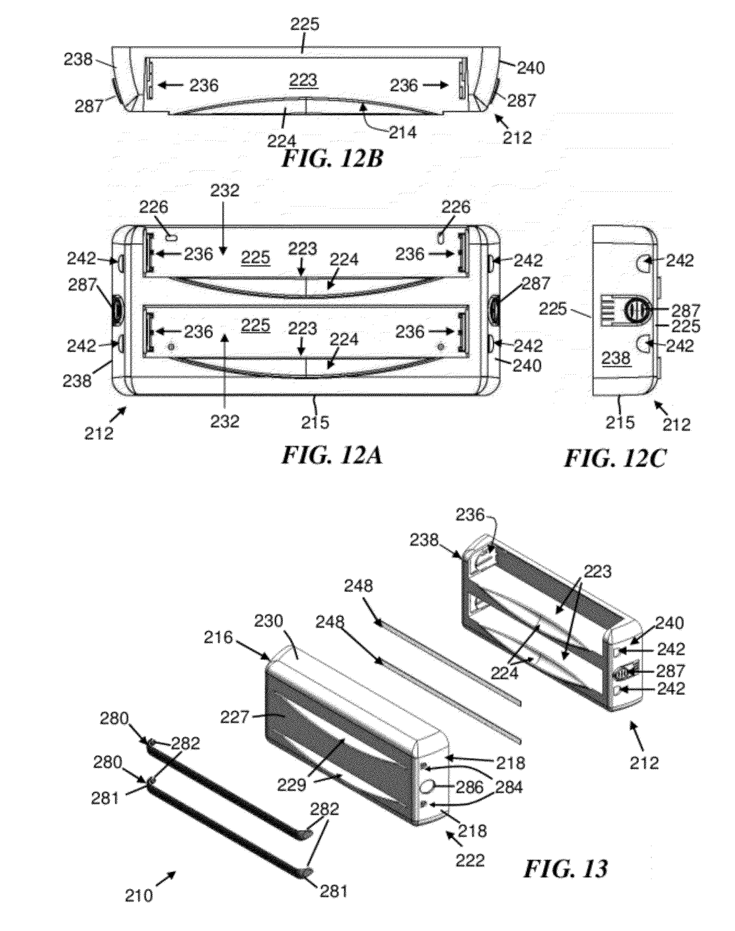

As stated above, FIG. 5B is a front perspective view at a reverse angle relative to FIG. 5A of the back housing 212 for rolls of sheet material of FIG. 5A. The back housing 212 includes two shelves 223 for rolls of sheet material which extend horizontally from the back wall 225 of the back housing 212 and which extend horizontally between the right vertical sidewall 240 and the left vertical sidewall 238 of the back housing 212. Each shelf 223 is recessed from the front of the front of the back housing 212, along the forward edge of the shelf 223, with a hand access recess 224 that extends downwardly across the central portion of the forward edge of each shelf 223 and extends downwardly from the horizontal plane of the shelf 223 and then curves forward towards the front of the back housing 212 to provide manual access to the loose end of a sheet S of a roll R of material stored on the shelf 223 as illustrated by FIGS. 14A-14C. Roll end holders 236 above and on the ends of each of the shelves 223 are formed in the left sidewall 238 and the right vertical sidewall 240. On the exterior right vertical sidewall 240 and the exterior left vertical sidewall 238 of the back housing 212 are a pair of button-shaped, i.e. annular latch bumps 287 extending out from the surfaces of the exterior of the right vertical sidewall 240 and the left vertical sidewall 238 of the back housing 212. The button-shaped, i.e. annular latch bumps 287 are provided for releasably securing the removable attachment of the front cover 222 to the back housing 212 by releasably engaging of the latch bumps 287 with a matching one of a pair of two latch passage holes 286 in the left sidewall 216 and the right sidewall 218 of the front cover 222. The front cover 222 can be slid off of the back housing 212 with the latch bumps 287 being withdrawn from the latch passage holes 286. In addition there are pockets 242 recessed in the right vertical sidewall 240 and the left vertical sidewall 238 of the back housing 212 both of which are seen in FIG. 12A the purpose of which will be explained below in connection with the description of FIGS. 12A-12C.

### Front Cover of Dispenser

As stated above, FIG. 5C is a front perspective view at a reverse angle relative to FIG. 5A of the front cover of the housing 222 of the dispenser 210 of FIG. 5A. FIG. 6A is a line drawing of a front elevational view of the front housing of the two roll dispenser 210 of FIG. 5C. FIG. 6B is line drawing of a plan view of the dispenser 210 shown FIG. 6A. FIG. 6C is line drawing of a right elevational view of the dispenser 210 shown FIG. 6A.

Referring to FIG. 5C and FIGS. 6A-6C, the front cover 222 includes a front panel 227, a top panel 230, a right sidewall 218 and a left sidewall 216 on the left side and the right side respectively of the front cover 222, and a bottom panel 226. The pair of horizontally extending, open, front access windows 229 are shown on the front panel 227. Since the open, front access windows 229 extend through the front surface 227 of the front cover 222, a user of the dispenser 210 can reach therethrough into the space defined by the curved surfaces of the downwardly curved, hand access recesses 224 in the shelves 223 shown in FIGS. 5A, 5B and 14A-14C. The blade guards 280 have been removed from FIG. 5C and FIGS. 6A-6B to show the pivot notches 284 on the left sidewall 216 in both FIGS. 5C and 6A. Pivot notches 284 for the other ends of the blade guards 280 are also shown on the right sidewall 218 in FIGS. 6A, 6C and 14A-14C. The pivot notches 284 are provided to support the blade guards 280 on them as pivot points about which a blade guard 280 can be raised to expose a sheet S to a cutter blade 248 as illustrated by the sequence of views shown in FIGS. 14A-14C. Each open front access window 229 is located below the pair of pivotable transverse blade guards 280 shown in FIGS. 5A, 9 and 14A-14C. Latch through-holes 286 are shown on the left sidewall 216 and the right sidewall 218 as shown in FIGS. 6A and 6C.

### Pivotable Blade Guards

FIGS. 7A-7C are views of an exemplary pivotable blade guard 280, which are shown installed on the dispenser 210 in FIGS. 5A and 9. FIG. 7A is a front elevation, FIG. 7B is a plan view and FIG. 7C is a right elevation of the pivotable blade guard 280. The pivotable blade guards 280 are pivotably supported by pivot bumps 282 (shown in FIGS. 7A-7C) on the right and left rounded and curved ends 281 of the blade guards 280 which are rotatably secured in the pivot holes 284 in the left sidewall 216 of the front cover 222 and by pivot notches 284 on the right sidewall 218 of the front cover 222 as shown in FIGS. 5C, 6A, 6C, and 13. The blade guards 280 are composed of a resilient, flexible plastic material such as ABS and HIPS which can be deflected to spread the pivot bumps 282 sufficiently to clear the peripheries of the pivot notches 284 when installing the pivot bumps 282 in the pivot notches 284 in the front cover 222. Alternatively, the blade guards can be supported by threaded fastener screws inserted into matching threaded bores in the rounded and curved ends 281 of the blade guards 280 as will be well understood by those skilled in the art.

### Cutter Blades

FIGS. 8A-8C are views of a serrated cutter blade 248 of the type shown installed in FIGS. 10B and 14A-14C which is exemplary of the cutter blades 248 of this invention. FIG. 8A is a front elevation, FIG. 8B is a plan view and FIG. 8C is a right elevation of the serrated cutter blade 248.

The serrated edges 279 are installed on the front cover 222 of the dispenser 210 at the top of the open, front access windows 229. FIG. 8A is an elevational view, FIG. 8B is a plan view and FIG. 8C is a right elevational view of the cutter blade 248. The cutter blades 248 are attached to the surface of the front housing 222 immediately behind the pivotable blade guards 280, with the serrated edges 279 facing downwardly at a position at which the blade guards 280 cover the corresponding serrated edges 279. The blade guards 280 are attached to the front of the front cover 222 so that they may pivot. Each kitchen rolls R is attached to the roll end holders 236 on the shelf 223 of the back housing 212 with an over the top and down feed. The front cover 222 is placed over the back housing 212 to form the assembled two-roll dispenser 210.

### Assembled Roll Dispenser

FIG. 9 is a perspective pictorial elevational view of the assembled two-roll dispenser 210 of FIGS. 5A-5C. FIGS. 10A and 10B are right side elevations of the dispenser 210. FIG. 10A is a right elevation of the dispenser 210 showing many of the features shown in FIG. 9. In FIG. 9, the latch bumps 287 of the back housing 212 are shown projecting through the latch through holes 286 on both the left sidewall 216 and the right sidewall 218 (FIG. 10A) of the front cover 222. The blade guards 280 are shown in the down position at the tops of the front access windows 229, so that the front access windows 229 provide safe manual access to sheet material through the front panel of the front cover 222 as shown in FIG. 9. As stated above, the blade guards 280 protect the user from the blades 248 behind them. The curved, hand access recesses 224 which extend down at the forward edges 214 of the shelves 223 shown below the blade guards 280 are visible through the front access windows 229. Section line A-A′ relates to a right side elevation of the dispenser 210 shown in FIG. 10B.

FIG. 10B is a section taken along line A-A′ in FIG. 9 showing the interior of the dispenser 210. The roll shelves 223 are shown with the curved sections of the hand access recesses reaching down and then forward towards the plane of the front panel 227 of the front cover 222 of the dispenser 210. The roll end holders 236 are shown form on the interior of the left sidewall 216 of the back housing 212. The cutter blades 248 are shown secured to the interior of the front panel 227 behind the blade guards 280 and enough above the level of the roll shelves 223 to avoid cutting the user of the dispenser 210. The bottom panel 215 of each compartment 232 of the back housing 212 is shown below the hand access recesses 224 in the back housing 212. To engage with the sheet material when pulled upwardly, the cutter blades 248 extend below the upper edges of the front access windows 229 as will be seen in FIG. 14B

FIG. 11 is a plan view of the front cover 222 of the dispenser 210 of FIG. 10A. The top surface 230 of the front cover 222 is located between the left sidewall 216 and the right sidewall 218 and behind the front panel 227 and the blade guard 280 with its rounded and curved ends 281 which wrap around portions of the left sidewall 216 and the right sidewall 218.

FIGS. 12A-12C are three views of the back housing 212 of the dispenser 210. FIG. 12A is a front elevation, FIG. 12B is a plan view and FIG. 12C is a left elevation on the right side of the front elevation. The roll end holders 236 are shown form on the interior of the left vertical sidewall 238 and the right vertical sidewall 240 of the back housing 212. There are four pockets 242 which are hollows in the exteriors of the sidewalls 238 and 240 of the back housing 212 provided to receive the inwardly projecting portions of the four pivot notches 242 in the front cover 222. Preferably, the pivot notches 284 project behind the inside wall of the front cover 222 and in that case, the pockets 242 which are recessed room for the pivot notches 284 which have room to extend into them. The remaining elements of the back housing 212 including the front access recesses 224, left and right sidewalls 238/240, annular latch bumps 287, compartments 232, back wall 225, and bottom panel 215 are described above. Fastener holes 226 are provided in the back wall 225 of housing 212 for mounting on a vertical surface.

FIG. 13 is an exploded view of the two roll dispenser 210 of FIGS. 5A and 9, the elements of which are described above.

### Cutting Sheet Material into Individual Sheets

FIGS. 14A-14C are partial sections of one of the compartments 232 of the dispenser illustrating the sequence of cutting of a roll R of sheet material with a sheet S extending therefrom through the dispensing path 228 as shown in FIG. 14A. The dispensing path 228 comprises the space defined by the access window 229 in the front cover 222 and the hand access 224 on the forward edge of the shelf 223. An individual sheet S is shown in FIG. 14A extending as a loose end of a roll R of sheet material into the dispensing path 228. In FIG. 14B, the sheet S is shown having been extracted from the dispensing path 228 where it is in engagement with the cutting edge of the cutter blade 248 and lifting up the blade guard 280. FIG. 14C shows that the sheet S′ has been cut away from the roll R and with a new sheet S hanging down into the dispensing path 228 ready to be dispensed efficiently and with the blade guard having fallen back down into the position shown in FIG. 14A.

FIGS. 14A-14C also show details of the structure of the back housing 212 and the operation of a cutter blade 248 and the blade guard 280 juxtaposed therewith. When accessing a sheet S to be obtained from the dispenser 210, a consumer reaches through a selected open, front access windows 229 into the access recess opening 224 to pull out the desired length of a sheet S from the position shown in FIG. 14A. The consumer will then lift the sheet S upwardly as shown in FIG. 14B to raise the blade guard 280 thereby permitting the cutting surface of the cutter blade 248 to sever the sheet S from the remainder of the sheet material on the roll R. Then as shown in FIG. 14C, the consumer pulls against the cutter blade 248 in a crossing action thereby cutting the sheet material into a separate sheet S′. The other result is that the resulting end of the sheet material S which will be the next tab of product falls down into the roll openings provided by the front access window 229 and the opening 224 on the shelf 223 and the blade guard 280 drops back down into place to help prevent accidental injury to the consumer when reaching in for the next

FIG. 15 shows the dispenser 210 of FIGS. 5A and 5C including the front panel 227 with the access recesses 224 and showing the location of the wide dispensing paths 228 through the front access windows 229, but with the blade guards 280 removed showing the location of the serrated cutter blades 248 secured to the front cover 222 above the open front access windows 229. Since the back housing 212 is not included and the access recesses 224 which cooperate with the front access windows 229 are not present in FIG. 15.

While the primary description of the dispensers for roll material have been directed to devices configured for use in the kitchen or for dispensing materials of comparable size, it will be seen that no limitations have been placed upon the size or dimensions of the dispenser. Accordingly, the dispenser for roll material may be scaled up to serve as a dispenser for larger rolls of material, e.g., bolts of fabric on rolls to provide for the convenient cutting to length of fabric from those rolls. Such a device will be most useful in fabric and yard good stores, as well as in other operations (industrial, retail sales, etc.) where lengths of material must be cut from continuous rolls of material.

It is to be understood that the present invention is not limited to the embodiments described above, but encompasses any and all embodiments within the scope of the following claims.

What is claimed is:

1. A dispenser for roll materials, comprising:
a back housing and a front cover removably installed on the back housing;
the back housing having a housing front, a back panel and mutually opposed left and right sides with at least one shelf extending between the left and right sides, the shelf extending forward from the back panel towards the housing front of the back housing;
the shelf having a shelf front at the front of the back housing and the shelf front having a forward edge which is downwardly sloped;
the forward edge comprising a front ledge or a front access recess extending downwardly from the shelf front;
a front cover removably installed over the back housing having at least one sheet passageway formed therethrough aligned with the forward edge when the front cover is installed;
the front cover and the back housing forming a compartment above the shelf;
a dispensing path for sheet material formed by the forward edge and the sheet passageway; and
cutter means including a cutter blade affixed to the front cover proximate to the dispensing path.

2. The dispenser for roll materials according to claim 1, further including at least one roll retainer extending upwardly from the forward portion of the shelf generally opposite the front ledge.

3. The dispenser for roll materials according to claim 1, further including:
a bottom panel extending between the left and right side panels and forward from the back panel of the cabinet; and
a paper towel holder depending from the bottom panel.

4. The dispenser for roll materials according to claim 3, wherein the paper towel holder comprises spaced apart, first and second arms flexibly mounted to the bottom panel, the arms being adapted to hold a paper towel roll removably therebetween.

5. The dispenser for roll materials according to claim 1, further including:
a cutter handle having a track end and a blade end opposite the track end;
a slide apparatus extending from the track end of the cutter handle,
the slide apparatus being captured within and traveling along the cutter track of the front cover;
resilient first and second rotary wheels captured within the blade end of the cutter handle; and
a blade captured between the rotary wheels, the blade having a periphery protruding from the blade end of the cutter handle.

6. The dispenser for roll materials according to claim 1, further including:
mutually opposed, left and right lateral flanges extending from the front cover, each of the flanges having at least one latch passage defined therethrough; and
at least one resilient latch protruding from each of the side panels of the cabinet, the resilient latches selectively engaging the corresponding latch passages of the lateral flanges of the front cover to secure the front cover removably to the cabinet.

7. A dispenser for roll materials, comprising:
a cabinet having a back panel and mutually opposed left and right side panels;
at least one shelf extending between the left and right side panels, the shelf extending forward from the back panel, the shelf having a forward edge;
a front ledge depending from the forward edge of the shelf;
at least one roll retainer extending upwardly from the forward portion of the shelf generally opposite the front ledge;
a front cover removably installed over the front ledge of the at least one shelf, the front cover having at least one sheet passageway formed therethrough and a top panel, the panels, the shelf, the front ledge of the cabinet, and the top panel of the front cover defining at least one compartment therein, the sheet passageway-communicating with the compartment; and
at least one cutter movably disposed on the front cover.

8. The dispenser for roll materials according to claim 7, further including:
at least one cutter track disposed laterally across the front panel, the cutter being secured to and traveling laterally along the cutter track; and
a blade extending from the cutter, the blade extending through the sheet passageway of the front cover.

9. The dispenser for roll materials according to claim 8 further including:
a cutter handle having a track end and a blade end opposite the track end;
a slide apparatus extending from the track end of the cutter handle,
the slide apparatus being captured within and traveling along the cutter track of the front cover;
resilient first and second rotary wheels captured within the blade end of the cutter handle; and
a blade captured between the rotary wheels, the blade having a periphery protruding from the blade end of the cutter handle.

10. The dispenser for roll materials according to claim 7, further including:
mutually opposed left and right lateral flanges extending from the front cover, each of the flanges having at least one latch passage defined therethrough; and
at least one resilient latch protruding from each of the side panels of the cabinet, the resilient latches selectively engaging the corresponding latch passages of the lateral flanges of the front cover to secure the front cover removably to the cabinet.

11. A dispenser for roll materials, comprising:
a dispenser having a back housing and a front cover;
the back housing including a back wall, mutually opposed left and right sidewalls, a front end and a shelf for sheet material;
the shelf extending between the left and right side panels and forward from the back wall and with the shelf having a forward edge proximate to the front end;
an access recess which is downwardly curved depending from the forward edge of the shelf;
the front cover removably installed onto the back housing with the front cover having an open window formed therethrough;
a dispensing path between the access recess and the open window; and
at least one cutter blade disposed on the front cover proximate to the dispensing path.

12. The dispenser for roll materials according to claim 11, further including:
at least one cutter blade disposed laterally across the front cover;
the cutter blade being adjacent to the dispensing path.

13. The dispenser for roll materials according to claim 16, further including a blade guard disposed in front of the cutter blade rotatable to expose the cutter blade.

14. The dispenser for roll materials according to claim 1 including a blade guard disposed in front of the cutter blade rotatable to expose the cutter blade.

15. The dispenser for roll materials according to claim 11, wherein the cabinet and the front cover are formed of plastic.

16. The dispenser for roll materials according to claim 12, wherein the cabinet and the front cover are formed of plastic.

17. The dispenser for roll materials according to claim 13, wherein the cabinet and the front cover are formed of plastic.

18. The dispenser for roll materials according to claim 14, wherein the cabinet and the front cover are formed of plastic

19. The dispenser for roll materials according to claim 14 wherein the blade guard is supported pivotally on the sidewalls of the front cover.

20. The dispenser for roll materials according to claim 14 wherein the front cover and the back housing are releasably joined by latch through holes in the sidewalls of the front cover and latch bumps on the sidewalls of the back housing.
